(19) United States
(12) Patent Application Publication
(10) Pub. No.: US 2008/0051252 A1
(43) Pub. Date: Feb. 28, 2008

(54) Apparatus for facilitating release of the parking lock

(75) Inventor: Naoki Nishimura, Nishikamo-gun (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 11/882,395

(22) Filed: Aug. 1, 2007

(30) Foreign Application Priority Data
Aug. 28, 2006 (JP) 2006-230963

(51) Int. Cl. B60T 1/06

(52) U.S. Cl. 477/92; 192/219.4

(57) ABSTRACT

When releasing a parking lock of an automatic transmission, an apparatus for facilitating release of the parking lock executes a routine to apply torque to a parking gear in a direction that will reduce an applied load between the parking gear and a parking pole while movement of a driving wheel is in a restricted state, and to reduce the restricting force on the driving wheel until the parking gear is rotated by the torque.

### INCORPORATION BY REFERENCE

The disclosure of Japanese Patent Application No. 2006-230963 filed on Aug. 28, 2006, including the specification, drawings and abstract is incorporated herein by reference in its entirety.

### BACKGROUND OF THE INVENTION

1. Field of the Invention

The invention relates to an apparatus that facilitates release of a parking lock of an automatic transmission by reducing the applied load on the parking lock.

2. Description of the Related Art

When a vehicle provided with an automatic transmission starts to run after it was stopped with the shift lever in the P range, the driver shifts the shift lever from the P range to the R or D range or the like. That is, the driver shifts the shift lever out of the P range. If the vehicle was stopped on an upward slope, an applied load to the portion where the parking pole and the parking gear are engaged may be excessive due to torque transferred from the driving wheels which are associated with the weight of the vehicle. As a result, the parking pole may not easily disengage, making it difficult to shift the shift lever out of the P range.

Japanese Patent Application Publication No. 9-286312 (hereinafter referred to as “JP-A-9-286312”) and Japanese Patent Application Publication No. 2006-074894 (hereinafter referred to as “JP-A-2006-074894”) describe apparatuses for reducing the load on the parking lock in order to facilitate release of the parking lock that are aimed to prevent this kind of phenomenon. That is, when shifting out of the P range, these apparatuses described in JP-A-9-286312 and JP-A-2006-074894 facilitate the shift by using output from the engine or an electric motor to apply torque to the parking gear against the torque that is acting on the parking gear from the driving wheels, thereby reducing the applied load.

However, with the apparatuses described in JP-A-9-286312 and JP-A-2006-074894, the torque against the torque from the driving wheels is usually applied to the parking gear when braking force from a footbrake is being applied to the driving wheels. Thus, the applied load is reduced by applying a large amount of torsion to the output shaft of the automatic transmission.

Accordingly, an extremely large amount of torque output is required to rotate the parking gear, which means that a tremendous amount of energy is consumed. Also, because a large amount of torsional force is applied to the output shaft, the durability of the output shaft and the power transmitting system related thereto must be increased, which may lead to an increase in size of the automatic transmission.

### SUMMARY OF THE INVENTION

This invention thus provides an apparatus that facilitates release a parking lock of an automatic transmission, i.e., facilitates a shift out of the P range by reducing the applied load with a small amount of torque output or no torque output at all.

Hereinafter, the structure and the operational effects of the invention will be described. One aspect of the invention relates to an apparatus that facilitates release of a parking lock by reducing an applied load on the parking lock, which includes a control portion that executes a parking lock load reducing routine to apply torque to a parking gear in a direction that will reduce the applied load between the parking gear and a parking pole while movement of a driving wheel is restricted by a restricting force, and to reduce the restricting force on the driving wheel until the parking gear is rotated by the torque, when releasing the parking lock of an automatic transmission.

The control portion applies torque in the direction that reduces the applied load and reduces the restricting force on the driving wheel until the parking gear is rotated. By reducing the restricting force on the restricted driving wheel in this manner, an excessive torsion is not generated on the output shaft of the automatic transmission and the parking gear may be rotated with the necessary angle with only a small amount of torque. Accordingly, the applied load from engagement between the parking gear and the parking pole may be reduced with only a small amount of torque output, thereby enabling an occupant of the vehicle to easily shift out of the P range.

A second aspect of the invention relates to an apparatus that facilitates release of a parking lock by reducing an applied load on a parking lock, which includes a driving wheel braking force adjusting apparatus that adjusts a braking force applied to a driving wheel; a parking gear torque outputting apparatus that outputs torque to rotate a parking gear; a parking gear rotation detector that detects rotation of the parking gear; a driving wheel restricting portion that executes a process to maintain movement of the driving wheel in a restricted state by controlling the adjustment of the braking force by the driving wheel braking force adjusting apparatus; an applied load reducing portion that executes a process to reduce the applied load by controlling the parking gear torque outputting apparatus to output torque to the parking gear in a direction that reduces the applied load between the parking gear and a parking pole, after movement of the driving wheel is maintained in a restricted state by the driving wheel restricting portion; and a driving wheel restricting force gradual reducing portion that executes a process to gradually reduce the restricting force on the driving wheel applied by the driving wheel restricting portion until the parking gear rotation detecting portion detects rotation of the parking gear of an amount equal to a reference angle while torque is being output by the applied load reducing portion.

In this way, the driving wheel restricting force gradual reducing portion gradually reduces the restricting force on the driving wheel by the driving wheel restricting portion until the parking gear rotation detecting portion detects rotation of the parking gear of an amount equal to the reference angle. As a result, even with only a small amount of torque output, the applied load can be reduced thus enabling an occupant of the vehicle to easily shift out of the P range.

A third aspect of the invention relates to an apparatus that facilitates release of a parking lock by reducing an applied load on a parking lock, which includes a control portion that executes a parking lock load reducing routine which reduces a binding force for transmitting torque between a driving wheel and a parking gear while movement of the driving wheel is restricted, when releasing the parking lock of an automatic transmission.

The control portion of this apparatus reduces the binding force for transmitting torque between the driving wheel and the parking gear. By reducing the binding force, it is possible to reduce or eliminate the torque applied to the parking gear from the driving wheel side. Therefore, even without specifically outputting torque, the applied load from engagement between the parking gear and the parking pole can be reduced, thus enabling an occupant of the vehicle to easily shift out of the P range.

A fourth aspect of the invention relates to an apparatus that facilitates release of a parking lock by reducing an applied load on a parking lock, which includes a driving wheel braking force adjusting apparatus that adjusts braking force applied to a driving wheel; a driving force transmitting clutch that is provided between a parking gear and the driving wheel; a driving wheel restricting portion that executes a process to maintains movement of the driving wheel in a restricted state by controlling the adjustment of the braking force by the driving wheel braking force adjusting apparatus; and a clutch binding force reducing portion that executes a process to reduce a binding force of the driving force transmitting clutch after movement of the driving wheel is maintained in the restricted state by the driving wheel restricting portion.

By reducing the binding force of the driving force transmitting clutch between the parking gear and the driving wheel, it is possible to interrupt or reduce the transmission of torque from the driving wheel to the parking gear, thereby reducing the applied load. Therefore, the applied load can be reduced without outputting torque, so an occupant of the vehicle to easily shift out of the P range.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a block diagram schematically showing a power transmitting system of a vehicle according to a first example embodiment of the invention;

FIG. 2 is a block diagram schematically showing a shift lever according to the first example embodiment;

FIG. 3 is a diagram of an automatic transmission according to the first example embodiment;

FIG. 4A is a schematic view showing the structure of a parking lock mechanism according to the first example embodiment while the parking lock is released;

FIG. 4B is a schematic view showing the structure of the parking lock mechanism according to the first example embodiment while the parking lock is applied;

FIG. 4C is a schematic view showing the parking brake mechanism when the direction of torque applied to the parking brake is opposite that shown in FIG. 4B;

FIG. 5 is a flowchart illustrating a routine for determining whether a condition for reducing the parking lock load is satisfied according to the first example embodiment;

FIG. 6 is a flowchart illustrating the first part of a parking lock load reducing routine according to the first example embodiment;

FIG. 7 is a flowchart illustrating the second part of the parking lock load reducing routine according to the first example embodiment;

FIG. 8 is a flowchart illustrating a routine for ending the parking lock load reduction according to the first example embodiment;

FIG. 9 is a timing chart showing one example of a process according to the first example embodiment;

FIG. 10 is a timing chart showing another example of a process according to the first example embodiment;

FIG. 11 is a timing chart showing yet another example of a process according to the first example embodiment;

FIG. 12 is a block diagram schematically showing a power transmitting system of a vehicle according to a second example embodiment of the invention;

FIG. 13 is a diagram of an automatic transmission according to the second example embodiment;

FIG. 14 is a flowchart illustrating a parking lock load reducing routine according to the second example embodiment;

FIG. 15 is a flowchart illustrating a routine for ending the parking lock load reduction according to the second example embodiment; and

FIG. 16 is a timing chart showing an example of a process according to the second example embodiment.

### DETAILED DESCRIPTION OF THE PREFERRED EMBODIMENTS

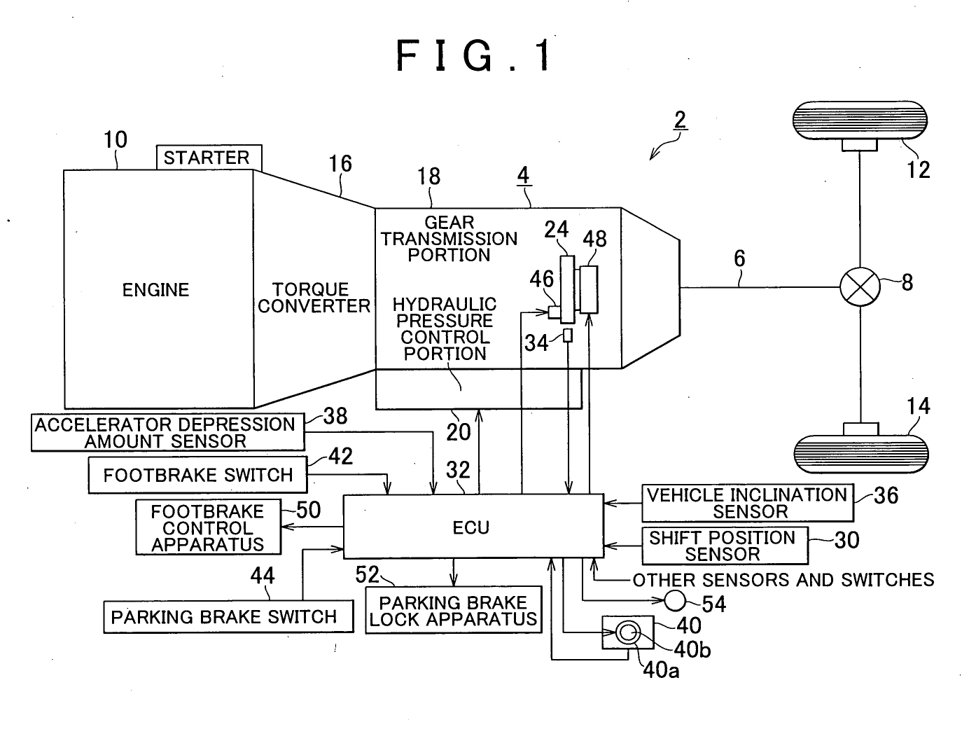

FIG. 1 shows a power transmitting system 2 (including a control system) of a vehicle equipped with a first example embodiment of the invention. Power from an engine 10 (an internal combustion engine in this example embodiment) which serves as the power source, is transmitted to driving wheels 12 and 14 via the power transmitting system which includes an automatic transmission 4, an output shaft 6, and a differential gear unit 8.

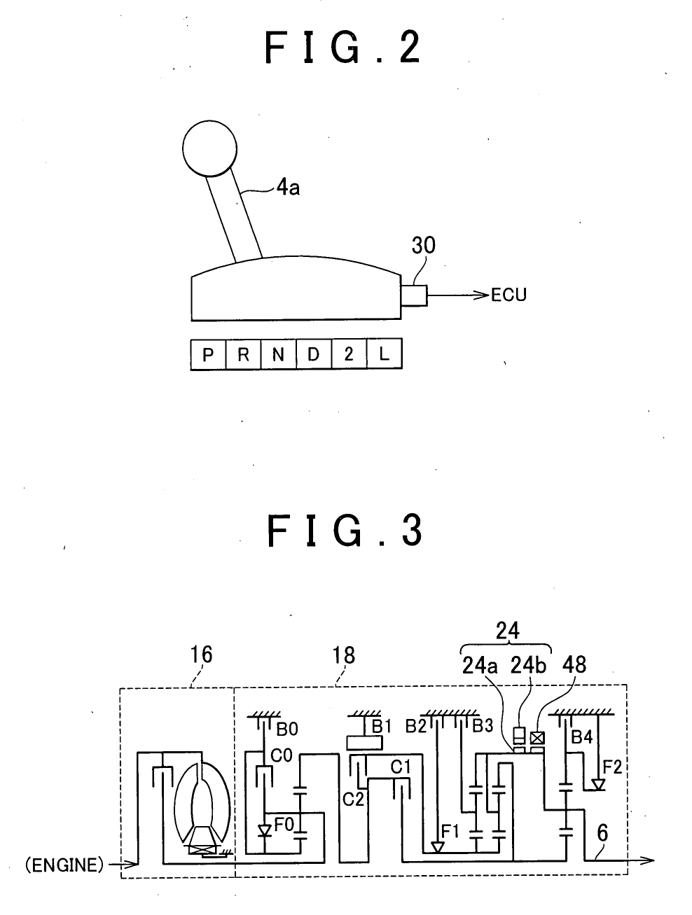

The automatic transmission 4 includes a torque converter 16, a gear transmission portion 18, and a hydraulic pressure control portion 20. An appropriate transmission gear ratio of the automatic transmission 4 may be selected by switching between a P range, a N range, a D range, a 2 range, and a L range according to the operating state (i.e., position) of a shift lever 4a, as shown in FIG. 2, provided in the vehicle cabin. In particular, when the automatic transmission 4 is in the D range, the transmission gear ratio of the automatic transmission 4 is automatically selected according to the running state. In the P range, a parking lock mechanism 24, which will be described later, is activated which mechanically prevents the output shaft 6 from rotating.

As shown in the diagram of the automatic transmission 4 in FIG. 3, five forward speeds and one reverse speed can be established by selectively operating multiple disc clutches C0, C1, and C2, one-way clutches F0, F1, and F2, and brakes B0, B1, B2, B3, and B4.

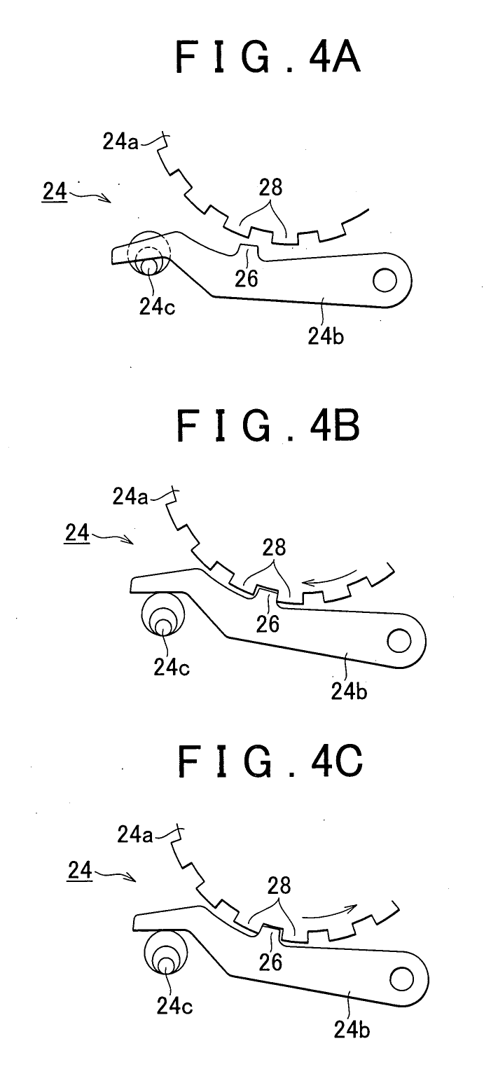

The parking lock mechanism 24 provided in the gear transmission portion 18 includes as its main components a parking gear 24a and a parking pole 24b that engages with the parking gear 24a, as shown in FIG. 4. FIG. 4A shows the parking lock mechanism 24 in a released state when the shift lever 4a is in a range other than the P range. FIGS. 4B and 4C show the parking lock mechanism 24 in a locked state when the shift lever 4a is in the P range. It should be noted that in FIGS. 4B and 4C, the direction of torque applied to the parking gear 24a from the driving wheels 12 and 14 (i.e., the direction of the arrow in the drawings) is reversed.

The parking gear 24a is arranged on an outer peripheral portion of a member that rotates together with the output shaft 6, as shown in FIG. 3. The parking pole 24b faces the parking gear 24a. In the diagram of FIG. 3, the parking pole 24b is shown above the parking gear 24a, but in actuality the parking pole 24b is arranged below the parking gear 24a, as shown in FIG. 4. When the shift lever 4a is shifted into the P range, this parking pole 24b is pushed upward by a parking lock cam 24c which is operatively linked to the shift lever 4a such that a pawl 26 of the parking pole 24b engages with teeth 28 on the parking gear 24a, as shown in FIGS. 4B and 4C, thereby preventing the output shaft 6 from rotating. When the shift lever 4a is shifted from the P range into another range, the parking lock cam 24c lowers the parking pole 24b such that the pawl 26 of the parking pole 24b disengages from between the teeth 28 on the parking gear 24a, thereby enabling the output shaft 6 to rotate.

A shift position sensor 30 is provided which is operatively linked to the shift lever 4a for shifting ranges (P, R, N, D, 2, L) and detects the shift position of the shift lever 4a. When the shift lever 4a is shifted, the shift position sensor 30 detects the shift position and outputs a shift position signal that indicates the shift position. An electronic control unit (ECU) 32 shown in FIG. 1 makes calculations based on the shift position signal and the outputs of various sensors and switches that are shown in FIG. 1, and then executes the control, which will be described later. The ECU 32 may be regarded as a control portion that, in addition to performing shift control of the automatic transmission 4, also controls the parking lock load reducing apparatus. Incidentally, the ECU 32 includes a CPU, ROM, RAM, input/output ports, and a drive circuit.

Various signals that indicate the operating state of the vehicle are input to the input side of the ECU 32. More specifically, the ECU 32 receives signals from various sensors and switches, including such as the shift position sensor 30, a rotation angle sensor 34 of the parking gear 24a, a vehicle inclination sensor 36, an accelerator depression amount sensor 38, a pushbutton switch 40a of a P (parking lock) release button 40, a footbrake switch 42, and a parking brake switch 44. Here, the rotation angle sensor 34 may be regarded as a parking gear rotation detector, and the pushbutton switch 40a may be regarded as a command input device.

From the results calculated based on the detected data and stored data, the ECU 32 outputs control signals and status signals to various actuators and other control apparatuses mounted in the vehicle. More specifically, some of the actuators and apparatuses and the like to which these signals are output include a parking pole driving apparatus 46, an electric motor 48 that applies torque to the parking gear 24a, a footbrake control apparatus 50 that adjusts the braking force applied to the driving wheels 12 and 14, a parking brake lock apparatus 52, an LED lamp 40b in the P release button 40, a buzzer 54, and a hydraulic pressure control portion 20. Here, the electric motor 48 may be regarded as a parking gear torque output apparatus, the footbrake control apparatus 50 may be regarded as a driving wheel braking force adjusting apparatus, and the combination of the LED lamp 40b and the buzzer 54 may be regarded as an indicating device.

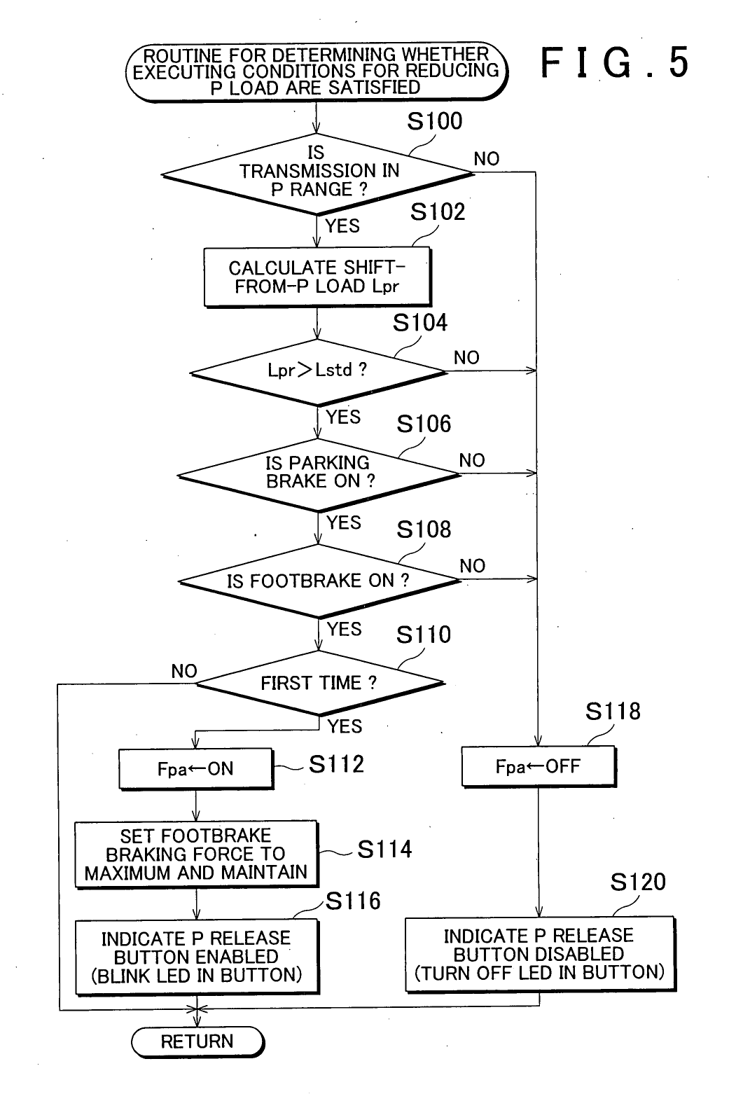

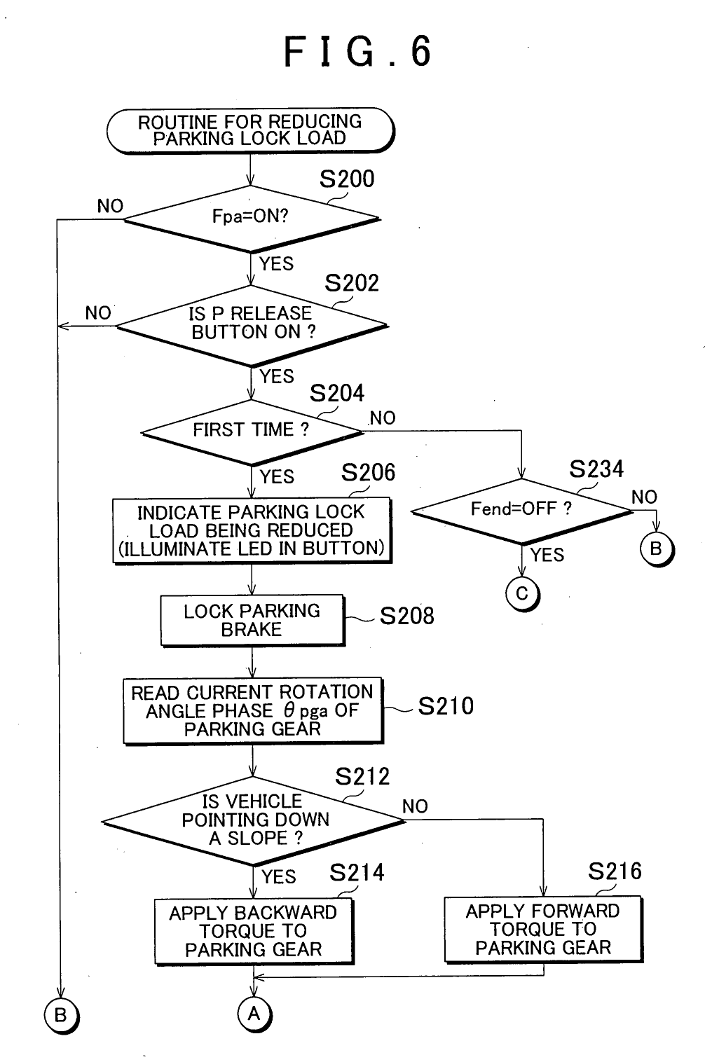

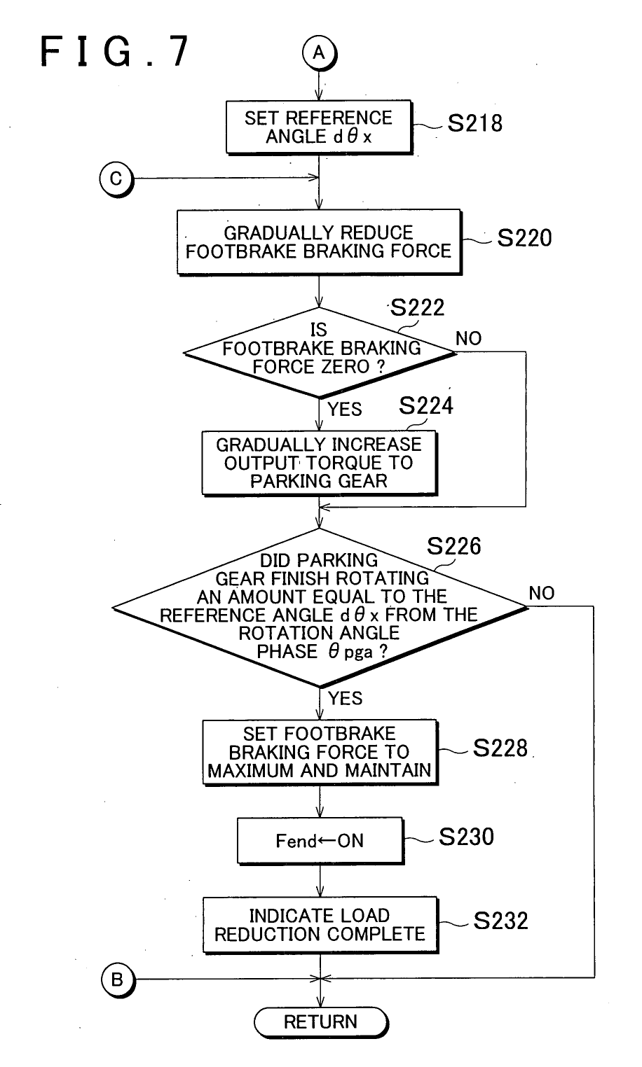

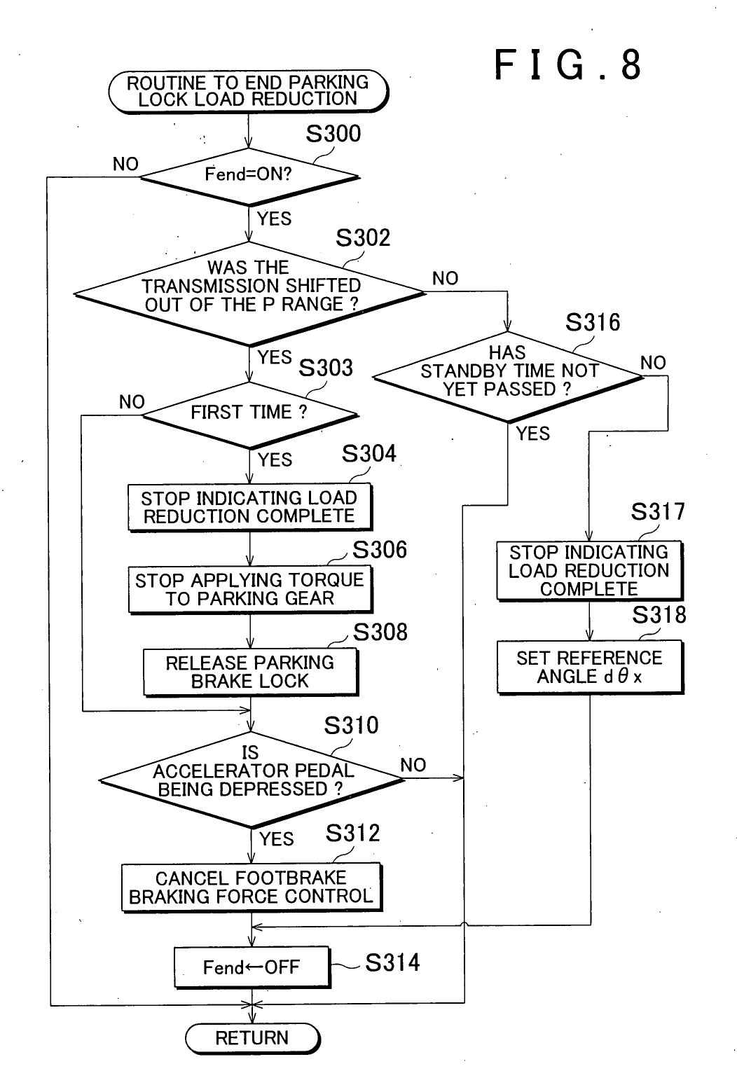

The ECU 32A executes a parking lock load reducing program. FIGS. 5 to 8 show flowchart of this program which includes a routine for determining whether a executing condition for reducing the parking lock load is satisfied (FIG. 5), a parking lock load reducing routine (FIGS. 6 and 7), and a routine for ending the parking lock load reduction (FIG. 8). These routines are repeatedly executed at regular intervals of time (i.e., cycles).

When the routine for determining whether the executing condition for reducing the parking lock load is satisfied (FIG. 5) starts, it is first determined whether the automatic transmission 4 is in the P range (S100). If automatic transmission 4 is not the P range (i.e., no in step S100), a shift-from-P flag Fpa is set to OFF (S118), a P release button disabled indication is displayed (S120), and a routine for determining whether the executing condition for reducing the parking lock load is satisfied ends. Incidentally, the P release button disabled indication in this case is a process that turns off the LED lamp 40b provided in the P release button or keeps that LED lamp 40b turned off.

If, on the other hand, the shift lever 4a is in the P range (i.e., yes in step S100), a shift-from-P load Lpr (i.e., the resistance force against the shift lever 4a when the shift lever 4a is shifted from the P range position into another range) is calculated (S102). This shift-from-P load Lpr is calculated using a map or a formula for computation according to the inclination of the vehicle by the output from the vehicle inclination sensor 36. That is, if the vehicle is inclined on an upward slope, torque in accordance with the degree of inclination is generated in the driving wheels 12 and 14. This torque is then transmitted to the parking gear 24a via the output shaft 6, thus increasing the applied load between the parking gear 24a and the parking pole 24b to increase the shift-from-P load Lpr.

Next it is determined whether the shift-from-P load Lpr exceeds a reference shift-from-P load Lstd (S104). This reference shift-from-P load Lstd is set to an even lower value than the shift-from-P load level at which even a driver (which corresponds to a vehicle occupant) with minimal strength can shift the shift lever out of the P range. Incidentally, the reference shift-from-P load Lstd may have a plurality of levels, any one of which is selected and set by the driver beforehand. Also, the shift-from-P load Lpr corresponds to the applied load between the parking gear 24a and the parking pole 24b so the determination in step S104 is equivalent to determining whether the applied load between the parking gear 24a and the parking pole 24b is greater than a reference load.

If Lpr is equal to or less than Lstd (i.e., no in step S104), steps S118 and S120 described above are executed and this cycle of the routine for determining whether the executing condition for reducing the parking lock load is satisfied ends. If, on the other hand, Lpr is greater than Lstd (i.e., yes in step S104), then it is next determined whether the parking brake is ON, i.e., whether the brake is being applied by the parking brake (S106). If the parking brake is OFF, i.e., if the brake is not being applied by the parking brake (i.e., no in step S106), steps S118 and S120 described above are executed and this cycle of the routine for determining whether the executing condition for reducing the parking lock load is satisfied ends.

If the parking brake is ON (i.e., yes in step S106), it is next determined whether the footbrake is ON (S108). If the footbrake is OFF (i.e., no in step S108), steps S118 and S120 described above are executed and this cycle of the routine for determining whether the executing condition for reducing the parking lock load is satisfied ends.

If the footbrake is ON (i.e., yes in step S108), then it is determined whether it is the first cycle of the routine (i.e., the first time) for which all of the conditions in steps S104, S106, and S108 are satisfied (S110). Incidentally, the state in which all of the conditions in steps S104, S106, and S108 are satisfied, i.e., the logical product of these conditions, may be regarded as the executing condition for reducing the parking lock load.

If this is the first cycle of the routine for which all of the conditions in steps S104, S106, and S108 are satisfied (i.e., yes in step S110), then a shift-from-P execution flag Fpa is set to ON (S112). Next, the braking force of the footbrake control apparatus 50 is set to the maximum braking force and maintained there, or if the braking force is already at the maximum braking force, it is maintained there (S114). Then an indication of “the P release button 40 is enabled” is displayed (S116). This enabled indication is displayed by blinking the LED lamp 40b provided in the P release button 40.

Then this cycle of the routine for determining whether the executing condition for reducing the parking lock load is satisfied ends. In the next control cycle of this routine, even if the determinations in steps S100, S104, S106, and S108 are yes, it would not be the first cycle (i.e., no in step S110) so steps S112, S114, and S116 would not be executed.

The parking lock load reducing routine (FIGS. 6 and 7) effectively starts when the shift-from-P execution flag Fpa is set to ON by the routine for determining whether the executing condition for reducing the parking lock load is satisfied (FIG. 5). In the parking lock load reducing routine (FIGS. 6 and 7), it is first determined whether the shift-from-P execution flag Fpa is ON (S200). If the shift-from-P execution flag Fpa is OFF (i.e., no in step S200), then this cycle of the parking lock load reducing routine directly ends so this routine is effectively not performed.

If, on the other hand, the shift-from-P execution flag Fpa is ON (i.e., yes in step S200), it is next determined whether the P release button 40 has been turned on (S202). When the shift-from-P execution flag Fpa is set to ON, an indication that the P release button is enabled is displayed by blinking the LED lamp 40b so the routine waits for the driver to operate the P release button 40. Therefore, unless the P release button 40 is turned on (i.e., no in step S202), then this cycle of the parking lock load reducing routine directly ends.

If the driver turns the P release button 40 on (i.e., yes in step S202), it is next determined whether this is the first cycle of the routine (i.e., the first time) for which the determination in step S202 was yes with respect to the current indication that the P release button is enabled (S204). If it is the first time (i.e., yes in step S204), then an indication that the parking lock load is being reduced is displayed (S206). This indication is displayed by illuminating (continuous illumination) the LED lamp 40b in the P release button 40.

Next, the parking brake lock apparatus 52 locks the parking brake on (S208). Then the current rotation angle phase θpga of the parking gear 24a is read by the rotation angle sensor 34 (S210).

Next it is determined whether the vehicle is under a front-downward slope (i.e., the vehicle is pointing down a slope) based on the detection value of the vehicle inclination sensor 36 (S212). If the vehicle is pointing down a slope (i.e., yes in step S212), i.e., if forward torque is being generated in the driving wheels 12 and 14 (this case corresponds to FIG. 4B), the electric motor 48 is driven to apply backward torque to the parking gear 24a (S214). If, on the other hand, the vehicle is not pointing down a slope (i.e., no in step S212), i.e., if backward torque is being generated in the driving wheels 12 and 14 (this case corresponds to FIG. 4C), the electric motor is driven to apply forward torque to the parking gear 24a (S216). The amount of output torque in this case is determined according to the inclination of the vehicle as detected by the vehicle inclination sensor 36. As a result, torque of a degree that enables the output shaft 6 to rotate slowly is applied to the parking gear 24a while the driving wheels 12 and 14 are not braked.

Once the electric motor 48 applies torque to the parking gear 24a in step S214 or step S216, a reference angle dθx is then set (S218). This reference angle dθx indicates a rotational transfer angle from the state in which the teeth 28 of the parking gear 24a are engaged with the side of the pawl 26 of the parking pole 24b under a pressure contact state as shown in FIGS. 4B and 4C, to the state in which the pawl 26 of the parking pole 24b is sufficiently distanced from the teeth 28 of the parking gear 24a. The value of the reference angle dθx is set appropriately beforehand, but the sign is different depending on whether the vehicle is pointing down a slope.

Next, the footbrake braking force is gradually reduced by the footbrake control apparatus 50 (S220). That is, the footbrake braking force is reduced in predetermined unit amounts.

Then it is determined whether the footbrake braking force has become zero by gradually reducing the braking force (S222). If there is still braking force from the footbrake (i.e., no in step S222), then it is next determined whether the parking gear 24a has finished rotating an amount equal to the reference angle dθx from the rotation angle phase θpga (S226). If the parking gear 24a has not yet finished rotating an amount equal to the reference angle dθx (i.e., no in step S226), then this cycle of the parking lock load reducing routine directly ends.

In the next control cycle the determinations in steps S200 and S202 will be yes but it will not be the first time (i.e., no in step S204) so it is determined whether an end routine flag Fend is OFF (S234). If the end routine flag Fend is OFF (i.e., yes in step S234), the footbrake braking force is gradually reduced (S220). Then, if the braking force of the footbrake has not yet reached zero (i.e., no in step S222), it is again determined whether the parking gear 24a has rotated an amount equal to the reference angle dθx (S226). If the parking gear 24a has still not rotated an amount equal to the reference angle dθx (i.e., no in step S226), this cycle of the parking lock load reducing routine directly ends.

This routine is repeated until the parking gear 24a finishes rotating an amount equal to the reference angle dθx (i.e., yes in step S226), whereupon the footbrake control apparatus 50 is then driven to return the footbrake braking force to the maximum braking force and keep it there (S228). Then the end routine flag Fend is set to ON (S230) and an indication that the load reduction is complete is output (S232). The indication that the load reduction is complete is output by outputting a buzzer sound from the buzzer 54. Then this cycle of the parking lock load reducing routine ends.

Incidentally, if the braking force of the footbrake becomes zero before the parking gear 24a rotates an amount equal to the reference angle dθx (i.e., yes in step S222), it is determined that the torque output by the electric motor 48 is insufficient so the torque output by the electric motor 48 is gradually increased (S224). As a result, the parking gear 24a rotates while the braking force is zero and when it has rotated an amount equal to the reference angle dθx (i.e., yes in step S226), the processes in steps S228, S230, and S232 described above are performed, so this cycle of the parking lock load reducing routine ends.

If the end routine flag Fend has been turned ON by the process in step S230, then in the next control cycle, the determinations in step S200 and S202 will be yes, the determination in step S204 will be no, and the end routine flag Fend will be ON (i.e., no in step S234) so the parking lock load reducing routine will effectively end.

The routine for ending the parking lock load reduction (FIG. 8) effectively starts when the end routine flag Fend is set to ON by the parking lock load reducing routine (FIGS. 6 and 7). In the routine for ending the parking lock load reduction (FIG. 8), it is first determined whether the end routine flag Fend is ON (S300). If the end routine flag Fend is OFF (i.e., no in step S300), then this cycle of the routine for ending the parking lock load reduction directly ends without this routine being effectively performed.

If, on the other hand, the end routine flag. Fend is set to ON by the parking lock load reducing routine (FIGS. 6 and 7) (i.e., yes in step S300), then it is determined whether the shift lever 4a has been shifted out of the P range based on the detection by the shift position sensor 30 (S302), as a process of waiting for the driver to shift from the P range into another range. Until the driver shifts from the P range into another range (i.e., no in step S302), it is determined whether a standby time has not yet passed (S316). This standby time is set taking into account the time that it takes for the driver to perform a shift. If the standby time has not yet passed (i.e., yes in step S316), then this cycle of the routine for ending the parking lock load reduction directly ends.

When the driver shifts out of the P range (i.e., yes in step S302), it is next determined whether this is the first cycle during which (i.e., the first time that) the shift lever 4a has been shifted out of the P range (S303). If it is the first time (i.e., yes in step S303), then the indication that the load reduction is complete is stops being output (S304). That is, the buzzer 54 is turned off.

Next, the electric motor 48 stops applying torque to the parking gear 24a (S306) and the parking brake lock apparatus 52 releases the parking brake lock (S308). As a result, the driver can release the parking brake.

Next it is determined whether the accelerator pedal is being depressed based on the detection by the accelerator depression amount sensor 38 (S310). If the accelerator pedal is not being depressed (i.e., no in step S310), this cycle of the routine for ending the parking lock load reduction directly ends.

In the next control cycle, even if the determinations in steps S300 and S302 are both yes, it is not the first time (i.e., no in step S303) so it is next determined whether the accelerator pedal is being depressed (S310). These steps are repeated until the accelerator pedal is depressed. When the driver then depresses the accelerator pedal to make the vehicle move (i.e., yes in step S310), the footbrake braking force control is cancelled (S312). That is, the braking force from the footbrake comes to correspond to the brake pedal operation by the driver. At this time, the driver has released the brake pedal so there is no longer any braking force applied by the footbrake, and thus no longer any restricting force applied to the driving wheels 12 and 14.

Then the end routine flag Fend is set to OFF (S314) and this cycle of the routine ends. In the next control cycle, the end routine flag Fend will be OFF (i.e., no step in S300) so the routine effectively ends.

Incidentally, in the routine for determining whether the executing condition for reducing the parking lock load is satisfied (FIG. 5), the determination in step S100 was no due to the fact that the shift lever 4a has been shifted out of the P range so the shift-from-P execution flag Fpa is set to OFF (S118). Therefore, the routine for determining whether the executing condition for reducing the parking lock load is satisfied (FIG. 5) is effectively not performed. Further, the determination in step S200 of the parking lock load reducing routine (FIGS. 6 and 7) is also no, so the parking lock load reducing routine is also effectively not performed.

If, on the other hand, the shift lever 4a is not shifted out of the P range before the standby time has passed (i.e., no in steps S302 and S316) as shown in FIG. 8, the indication that the load reduction is complete stops being output by stopping the buzzer sound from being output by the buzzer 54 (S317), and the reference angle dθx is reset (S318). The reference angle dθx in this case is set slightly larger than the reference angle dθx that was set in step S218 (FIG. 7). The reference angle dθx that was set in S218 may also be used after being gradually increased.

Then, the end routine flag Fend is set to OFF (S314) and this cycle of the routine for ending the parking lock load-reduction ends. As a result, in the parking lock load reducing routine (FIGS. 6 and 7), the determination in step S234 is yes again, so steps S220 and thereafter described above are executed. That is, the footbrake braking force is gradually decreased (S220) until the parking gear 24a has finished rotating an amount equal to the newly set reference angle dθx from the rotation angle phase θpga read in step S210. Incidentally, if the braking force after being gradually reduced is insufficient (yes in step S222), torque output is gradually increased (S224). As a result, when the parking gear 24a rotates an amount equal to the new reference angle dθx (yes in step S226), the footbrake braking force is set to the maximum braking force, as described above (S228). The end routine flag Fend is then set to ON (S230) and indication that the load reduction is complete is output (S232). Then the routine for ending the parking lock load reduction is effectively performed, as described above.

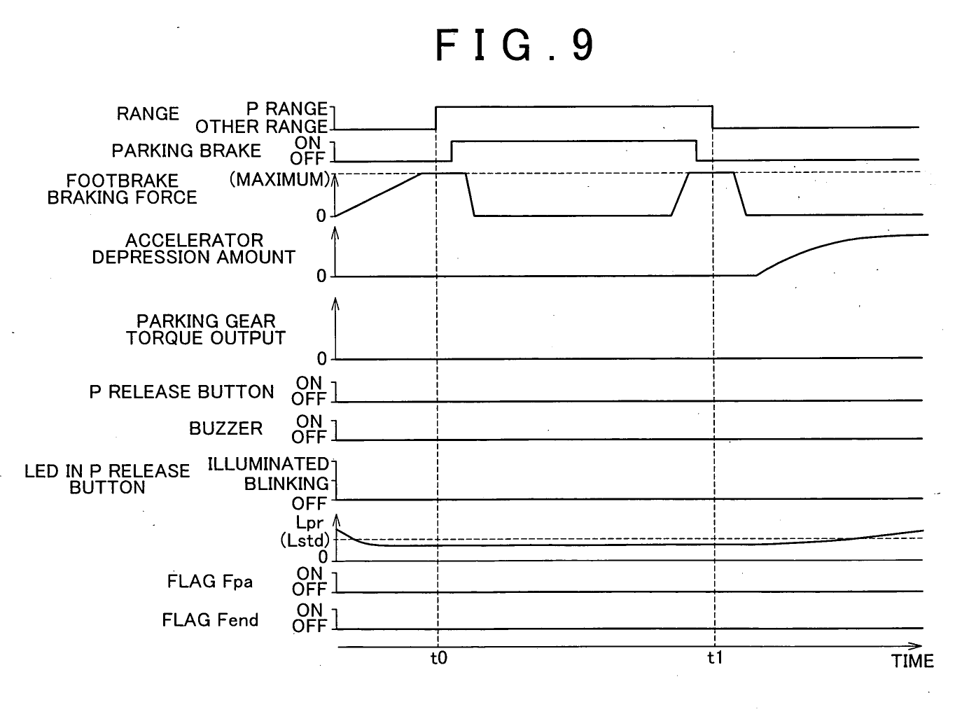

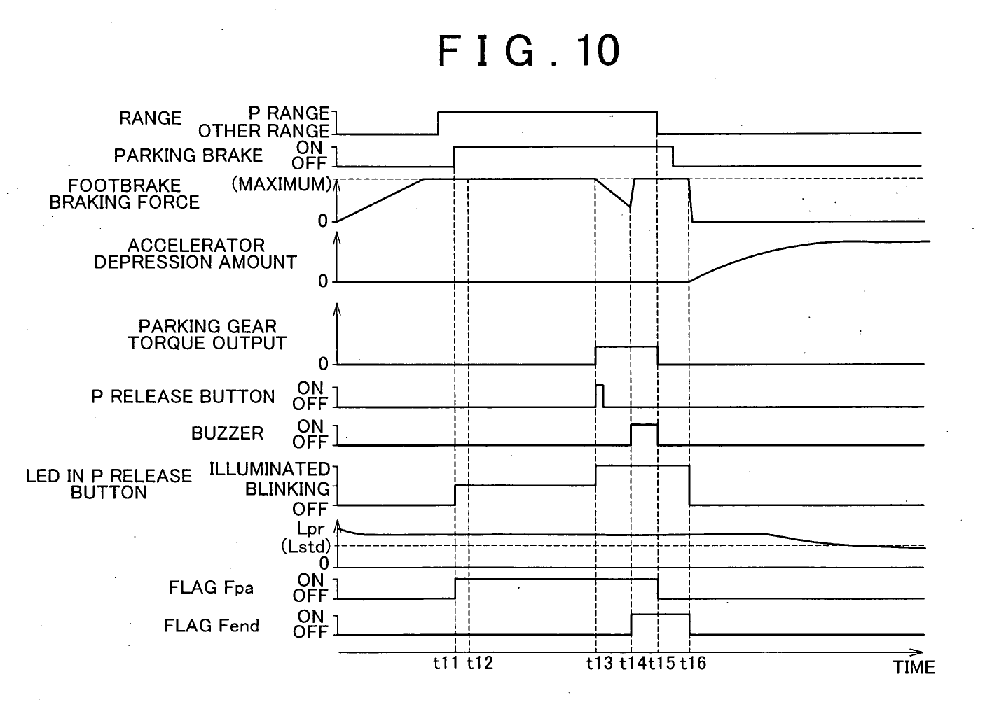

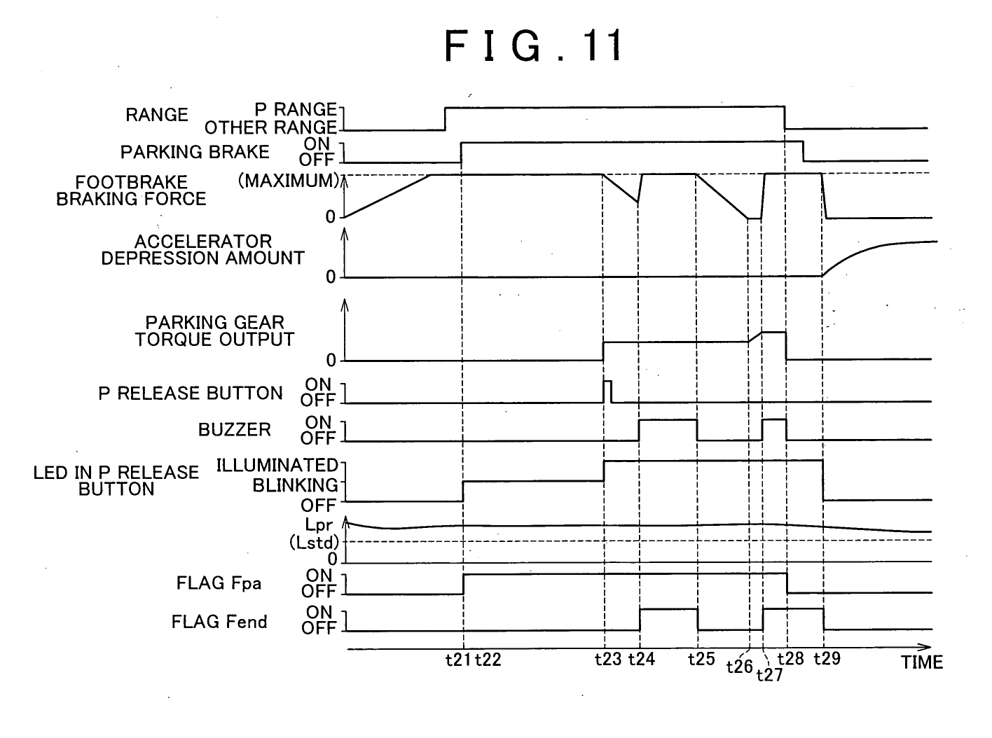

The timing chart in FIG. 9 shows control when the shift-from-P load Lpr does not exceed the reference shift-from-P load Lstd while the vehicle is stopped and the shift lever 4a is in the P range (t0 to t1) (FIG. 5; no in step S104). Therefore, the LED lamp 40b in the P release button 40 remains off (i.e., unlit) (S120), and the driver is able to shift from the P range into another range by operating the shift lever 4a (t1).

The timing chart in FIG. 10 shows the control that is executed when the shift-from-P load Lpr exceeds the reference shift-from-P load Lstd while the vehicle is stopped and the shift lever 4a is in the P range (FIG. 5, yes in step S104). The other conditions, i.e., that the parking brake be ON and the footbrake be ON, are both satisfied (i.e., yes in both steps S106 and S108) so the LED lamp 40b in the P release button 40 starts to blink (t11). Therefore, even if the driver releases the footbrake (t12), the braking force will not decrease but instead be maintained at the maximum braking force (S114; t12 on). Then when the driver pushes the pushbutton switch 40a of the P release button 40 on to start making the vehicle move (t13; yes in step S202), the LED lamp 40b illuminates (S206), torque is applied to the parking gear 24a (S214 and S216), and the footbrake braking force starts to be gradually reduced (S220). When the parking gear 24a finishes rotating an amount equal to the reference angle dθx as a result (t14; yes in step S226), the footbrake braking force is returned to the maximum braking force and kept there (S228) and the buzzer sound is output (S232). Then if the driver shifts the shift lever 4a from the P range into another range within the standby time (t15), the buzzer is turned off and torque stops being output to the parking gear 24a (S304 and S306). The footbrake braking force control is also cancelled as the accelerator pedal starts to be depressed (t16; S312).

The timing chart in FIG. 11 shows the control that is executed when the shift from the P range by the driver is difficult with the parking gear 24a rotating an amount equal to the initial reference angle dθx. Incidentally, times t21 to t24 are the same as the times t11 to t14 in FIG. 10 described above. However, in the routine for ending the parking lock load reduction (FIG. 8), which is performed after the end routine flag Fend was turned on when the shift lever 4a is still in the P range even after the standby time has passed (t25; no in step S316), the buzzer is turned off (S317). Therefore, a new reference angle dθx is set (S318), the end routine flag Fend is returned to off (S314), and steps S220 to S232 are repeated again. In FIG. 11, the braking force of the footbrake becomes zero before the parking gear 24a reaches the new reference angle dθx (t26; yes in step S222) so the output of the electric motor 48 is gradually increased (t26 to t27; S224). As a result, the parking gear 24a reaches the new reference angle dθx (t27; yes in step S226). Then the footbrake braking force is set to the maximum braking force (S228), the end routine flag Fend is set to ON (S230), and the routine for ending the parking lock load reduction (FIG. 8) is effectively performed. Then, the shift lever 4a is able to be shifted out of the P range by the driver so the process is the same as it was at times t14 to t16 in FIG. 10 (t27 to t29).

In the foregoing structure, the ECU 32 may be regarded as a driving wheel restricting portion, an applied load reducing portion, a driving wheel restricting force gradual reducing portion, a post-processing portion, and a re-executing portion, all of which are part of the parking lock load reducing apparatus of the invention. Step S114 may be regarded as a process of the driving wheel restricting portion. Steps S104, S106, S108, S112, S200, S202, S210, S212, S214, and S216 may be regarded as processes of the applied load reducing portion. Also, steps S104, S106, S108, S112, S200, S202, S218, S220, S226, and S230 may be regarded as processes of the driving wheel restricting force gradual reducing portion, steps S228, S310, and S312, may be regarded as processes of the post-processing portion, and steps S316, S318, and S314 may be regarded as processes of the re-executing portion.

The following effects can be obtained by first example embodiment described above. (A). In FIGS. 5 to 8, if it is determined by the executing conditions for reducing the parking lock load (S104, S106, and S108) that there is a need to reduce the parking lock load (i.e., yes in all of steps S104, S106, and S108), then the driving wheels 12 and 14 are restricted (S114) before the parking lock load reducing routine is executed. Then if there is a request by the driver to reduce the parking lock load (i.e., yes in step S202), the electric motor 48 applies torque to the parking gear 24a in a direction that reduces the applied load on the parking pole 24b by the parking gear 24a (S212 to S216). Moreover, the restricting force on the driving wheels 12 and 14 (i.e., the footbrake braking force in this case) is reduced until the parking gear 24a rotates. By reducing the restricting force on the g wheels 12 and 14 in this way, excessive torsion is not applied to the output shaft 6 of the automatic transmission 4 so the parking gear 24a can be rotated with the necessary angle (i.e., the reference angle dθx) with only a small amount of torque. As a result, the applied load from the engagement of the parking gear 24a and the parking pole 24b is reduced so that the driver can easily shift the shift lever 4a out of the P range even if not much torque is output from the electric motor 48.

(B). By having the parking lock load reducing routine effectively start in response to the driver pushing the pushbutton switch 40a of the P release button 40 (i.e., yes in step S202), the necessary time to execute the routine is evident. Because the intention of the driver is clearly evident in this way, the parking lock load reducing routine may be performed at a more appropriate time.

(C). In particular, when the operating state of the vehicle does not satisfy the executing conditions for reducing the parking lock load set by steps S104, S106, and S108, the parking lock load reducing routine will not effectively start even if the pushbutton switch 40a is turned on. Therefore, it is possible to prevent the parking lock load reducing routine from being started under an inappropriate operating state of the vehicle. Further, it is possible to prevent the parking lock load reducing routine from being started even if the driver mistakenly pushes the pushbutton switch 40a. Furthermore, when these kinds of conditions are satisfied, the time at which the parking lock load reduction is started may be appropriately determined, thus preventing the parking lock load reducing routine from being executed at an unnecessary time or when the vehicle is unstable.

(D). The driver is alerted to the fact that the parking lock load should be reduced by the blinking LED lamp 40b (S116) so the driver can easily understand that it will be difficult to shift the shift lever 4a out of the P range, and can execute the parking lock load reducing routine and then smoothly shift the shift lever 4a out of the P range.

Because the driver is notified that the parking lock load is being reduced by the illuminated LED lamp 40b (S206), the driver can understand that the parking lock load reducing routine is in the middle of being executed and thus will not needlessly repeat a shift out of the P range while the shift out of the P range is not possible. Moreover, a sense of uneasiness will not be imparted to the driver during the time that the shift out of the P range is not possible.

The driver is alerted to the fact that the parking lock load has finished being reduced and a shift out of the P range is now possible by the sound of the buzzer (S232) so the driver can quickly shift the automatic transmission 4 out of the P range and into another range.

(E). In addition, if it is determined for some reason that the applied load between the parking gear 24a and the parking pole 24b is not sufficiently reduced with one cycle of the parking lock load reducing routine (i.e., no in step S316), then the parking lock load reducing routine (S318, S314, and S220 to S232) may be executed again. As a result, the applied load can be sufficiently reduced so that a shift out of the P range is possible.

(F). If, after the parking lock load reducing routine, the driving wheels 12 and 14 return to being restricted (S228) and if there is an acceleration command from the driver (i.e., yes in step S310), the control to maintain the restricting force by the braking force on the driving wheels 12 and 14 is cancelled (S312). Accordingly, vehicle stability may be maintained and the driver is able to start driving smoothly after the routine to reduce the parking lock load is executed.

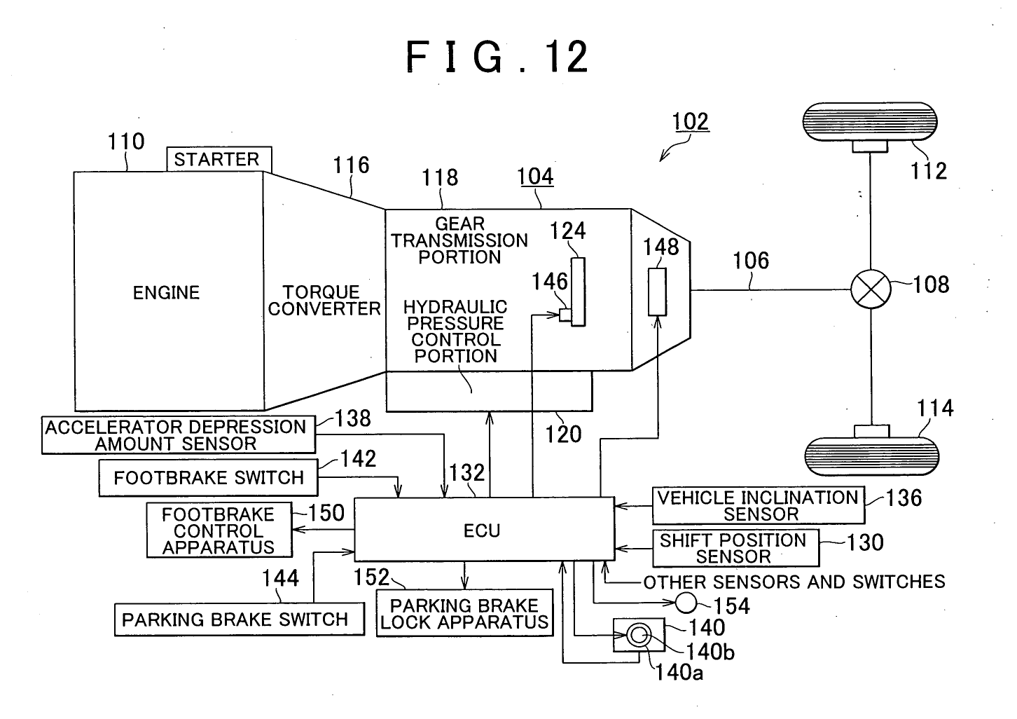

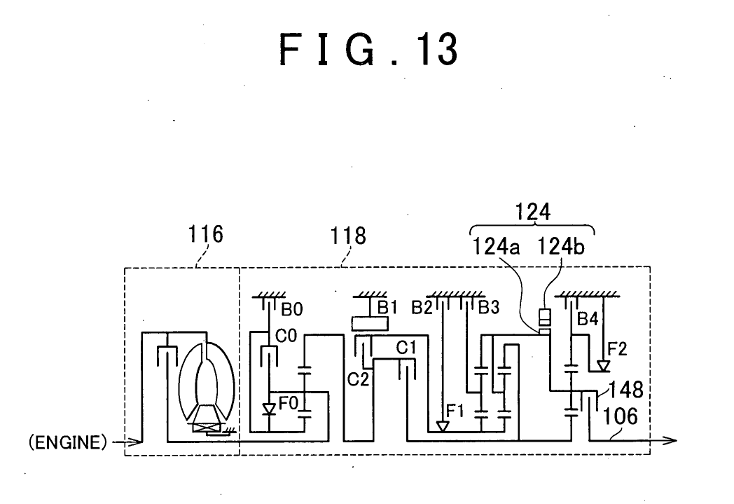

The hardware structure of a second example embodiment of the invention is as illustrated in the block diagram of a power transmitting system (including a control system) of a vehicle (hereinafter simply referred to as “power transmitting system”) 102 in FIG. 12 and the diagram of an automatic transmission 104 shown in FIG. 13. That is, both a parking lock mechanism 124, which includes a parking gear 124a and a parking pole 124b, and a parking pole driving apparatus 146 are provided, but no rotation angle sensor or electric motor that applies torque to the parking gear 124a is provided. Instead, an output shaft 106 of the automatic transmission 104 is provided with a driving force transmitting clutch mechanism 148 that can selectively establish (when engaged) or interrupt (when released) a power transmitting path between a driving wheel 112 and 114 and a gear transmission portion 118. The driving force transmitting clutch mechanism 148 may be regarded as a driving force transmitting clutch of the invention. An ECU 132 controls the engagement and release of this driving force transmitting clutch mechanism 148. The structure of all other hardware is the same as it is in the first example embodiment. In particular, a shift position sensor 130, a vehicle inclination sensor 136, an accelerator depression amount sensor 138, a P release button 140, a footbrake switch 142, a parking brake switch 144, a footbrake control apparatus 150, a parking brake lock apparatus 152, and a buzzer 154 are as described in the first example embodiment.

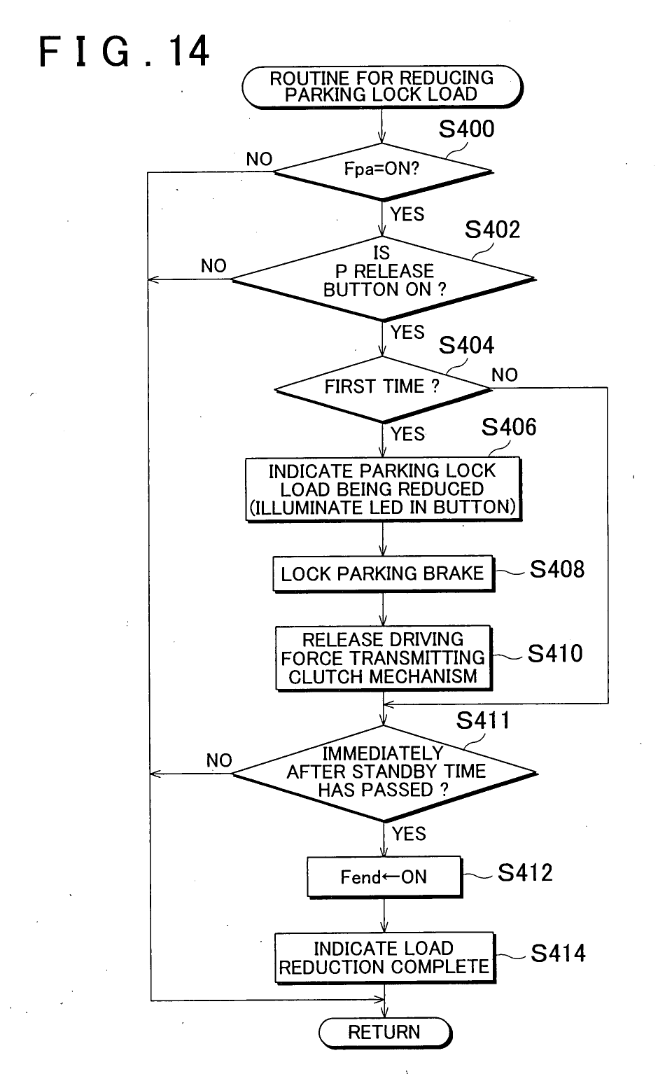

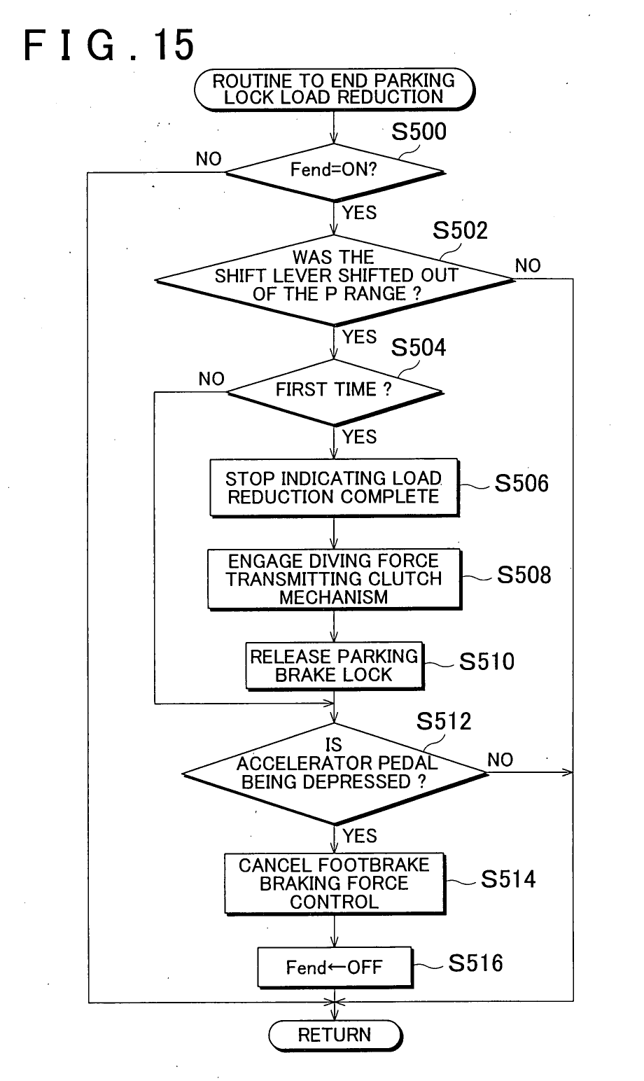

Regarding the routines executed by the ECU 132, the routines shown in FIG. 14 (a parking lock load reducing routine) and FIG. 15 (a routine for ending the parking lock load reduction) are repeatedly executed at fixed intervals of time (cycles) instead of the parking lock load reducing routine shown in FIGS. 6 and 7 and the routine for ending the parking lock load reduction shown in FIG. 8. However, the identical routine for determining whether the executing condition for reducing the parking lock load is satisfied, as shown in FIG. 5, is executed in the second example embodiment as well.

If all of the conditions in steps S104, S106, and S108 are satisfied in the routine for determining whether the executing condition for reducing the parking lock load is satisfied (FIG. 5), then the shift-from-P execution flag Fpa is set to ON (S112). As a result, the parking lock load reducing routine (FIG. 14) effectively starts. In this routine, first it is determined whether the shift-from-P execution flag Fpa is ON (S400). If the shift-from-P execution flag Fpa is OFF (i.e., no in step S400), then this cycle of the parking lock load reducing routine directly ends without the routine effectively being executed.

If the shift-from-P execution flag Fpa is ON (i.e., yes in step S400), then it is next determined whether the P release button 140 was turned on (S402). When the shift-from-P execution flag Fpa is set to ON the indication that the P release button is enabled is displayed by the blinking LED lamp 140b so the routine waits for the driver to operate the P release button 140. Therefore, unless the P release button 140 is turned on (i.e., no in step S402), then this cycle of the parking lock load reducing routine directly ends.

If the driver turns on the P release button 140 (i.e., yes in step S402), then it is determined whether this is the first cycle for which (i.e., the first time that) the determination in step S402 was yes for this P release button enabled indication (S404). If it is the first time (i.e., yes in step S404), then an indication that the parking lock load is being reduced is displayed (S406). This indication is displayed by illuminating (continuously illuminating) the LED lamp 140b in the P release button 140.

Next, the parking brake lock apparatus 152 locks the parking brake in the on state (S408), and the driving force transmitting clutch mechanism 148 is released (S410). As a result, torque proportional to the vehicle inclination that is transmitted from the driving wheels 112 and 114 via the output shaft 106 is not transmitted to the parking gear 124a. Then it is determined whether it is immediately after the standby time until the driving force transmitting clutch mechanism 148 is completely released has passed (S411). If the standby time has not yet passed (i.e., no in step S411), then this cycle of the parking lock load reducing routine directly ends. In the next control cycle, although the determinations in both steps S400 and S402 are yes, it will not be the first time (i.e., no in step S404) so it is determined whether it is immediately after the standby time has passed (S411). If the standby time has not passed (i.e., no in step S411), this cycle of the parking lock load reducing routine directly ends. When the standby time has passed after the routine is repeated in this manner, it would be immediately after that standby time has passed (i.e., yes in step S411) in the second routine so the end routine flag Fend is set to ON (S412) and an indication that the load reduction is complete is output (S414). The load reduction complete indication may be output by outputting a buzzer sound from the buzzer 154, as described in step S232 of FIG. 7. Then this cycle of the parking lock load reducing routine ends.

In the next control cycle, although the determinations in both steps S400 and S402 are yes, it is not the first time (i.e., no in step S404), nor is it immediately after the standby time has passed (i.e., no in step S411) so this cycle of the parking lock load reducing routine directly ends. In this way, the parking lock load reducing routine (FIG. 14) effectively ends.

As described above, the routine for ending the parking lock load reduction (FIG. 15) effectively starts when the end routine flag Fend is set to ON (S412). In this routine, it is first determined whether the end routine flag Fend is ON (S500). If the end routine flag Fend is OFF (i.e., no in step S500), then this cycle of the routine for ending the parking lock load reduction directly ends without the routine effectively being executed.

If the end routine flag Fend is set to ON in the parking lock load reducing routine (FIG. 14) described above (i.e., yes in step S500), then it is next determined whether the driver has shifted the shift lever 4a out of the P range based on the detection by the shift position sensor 130 (S502). Until the driver shifts the shift lever 4a out of the P range (i.e., no in step S502), this cycle of the routine for ending the parking lock load reduction directly ends.

When the driver shifts the shift lever 4a out of the P range (i.e., yes in step S502), it is then determined whether this is the first time that the shift lever 4a has been shifted out of the P range (S504). If it is the first time (i.e., yes in step S504), then the load reduction complete indication is stopped (S506), i.e., the buzzer 154 is turned off.

Next, the driving force transmitting clutch mechanism 148 is engaged (S508). That is, the driving force transmitting clutch mechanism 148 begins to transmit driving force between the driving wheel 112 and 114 side and the automatic transmission 104 side. Then the parking brake lock apparatus 152 releases the parking brake lock (S510). As a result, the driver is able to release the braking force of the parking brake.

Next, it is determined whether the accelerator depression amount sensor 138 has detected that the accelerator pedal is being depressed (S512). If the accelerator pedal is not being depressed (i.e., no in step S512), this cycle of the routine for ending the parking lock load reduction directly ends.

In the next control cycle, although the determinations in both steps S500 and S502 are yes, it is not the first time (i.e., no in step S504) so it is next determined whether the accelerator pedal is being depressed (S512). In this way, until the accelerator pedal is depressed (i.e., no in step S512), the routine for ending the parking lock load reduction described above will be repeated. Then when the driver depresses the accelerator pedal in order to make the vehicle move (i.e., yes in step S512), the footbrake braking force control is cancelled (S514). Here, the driver has released the brake pedal so no braking force from the brake pedal is applied and thus the driving wheels 112 and 114 are no longer restricted.

Then the end routine flag Fend is set to OFF (S516) and this cycle of the routine for ending the parking lock load reduction ends. In the next control cycle, the end routine flag Fend is OFF (i.e., no in step S500) so the routine for ending the parking lock load reduction effectively ends.

Incidentally, by shifting the shift lever 4a out of the P range, the determination in step S100 (FIG. 5) will be no, in which case the shift-from-P execution flag Fpa is set to OFF (S118). Therefore, the routine for determining whether the executing condition for reducing the parking lock load is satisfied (FIG. 5) effectively ends. Moreover, the determination in step S400 in the parking lock load reducing routine (FIG. 14) is also no so this routine effectively ends.

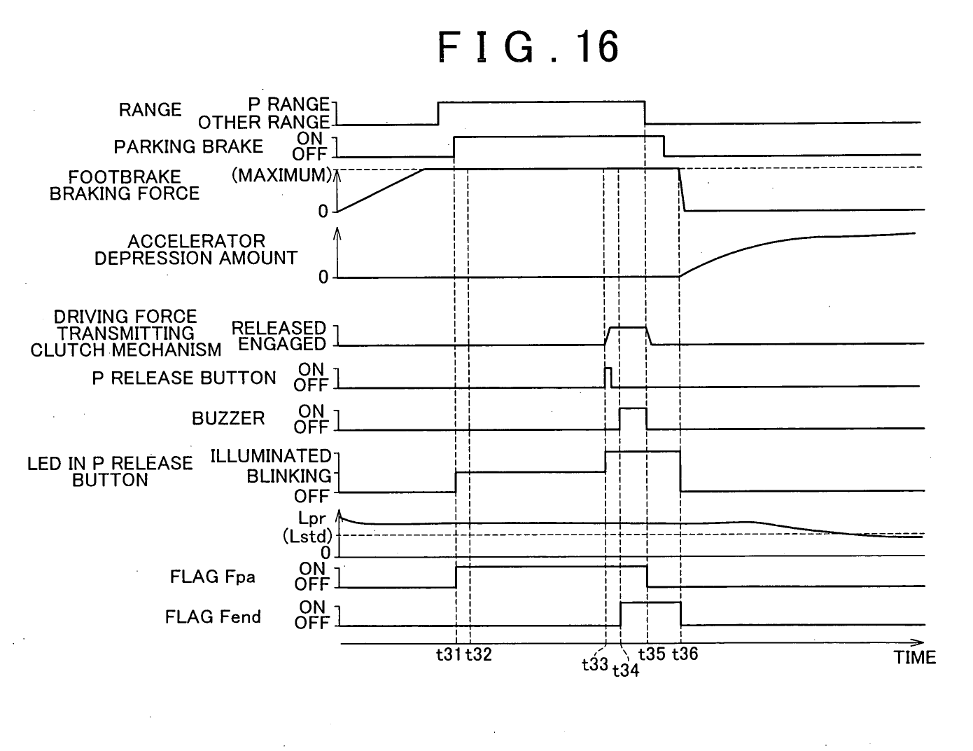

The timing chart in FIG. 16 shows control when the shift-from-P load Lpr exceeds the reference shift-from-P load Lstd while the vehicle is stopped (FIG. 5, yes in step S104). The other conditions, i.e., that the parking brake be ON and the footbrake be ON, are both satisfied (i.e., yes in both steps S106 and S108) so the LED lamp 140b in the P release button 140 starts to blink (t31). Therefore, even if the driver releases the footbrake, the braking force will not decrease but instead be maintained at the maximum braking force (S114; t32 on). Then when the driver pushes the pushbutton switch 140a of the P release button 140 in order to start making the vehicle move (yes in step S402), the LED lamp 140b illuminates (S406) and the driving force transmitting clutch mechanism 148 starts to release (S410; t33). As a result, the load applied to the parking pole 124b from the parking gear 124a is reduced so the buzzer sound is output after the standby time has passed (S414; t34). Then when the driver shifts the shift lever 4a from the P range into another range (i.e., yes in step S502; t35), the buzzer is turned off (S506) and the driving force transmitting clutch mechanism 148 is engaged (S508). Then, the footbrake braking force control is also cancelled as the accelerator pedal starts to be depressed (t36; S514).

The ECU 132 may be regarded as a driving wheel restricting portion, a clutch binding force reducing portion, and a post-processing portion, all of which are part of the parking lock load reducing apparatus of the invention. Also, step S114 may be regarded as a process of the driving wheel restricting portion and steps S104, S106, S108, S112, S400, S402, and S410 may be regarded as processes of the clutch binding force reducing portion. Also, steps S512 and 514 may be regarded as processes of the post-processing portion.

The following effects can be obtained by the second example embodiment described above. (A). In the routines shown in FIGS. 5, 14, and 15 described above, movement of the driving wheels are restricted before reducing the parking lock load (S114). Then when there is a request to reduce the parking lock load (i.e., yes in step S402), the driving force transmitting clutch mechanism 148 is released (S410) so that torque from the driving wheels 112 and 114 from the inclination of the vehicle is not applied to the parking gear 124a. As a result, excessive torsion is not generated in the output shaft 106 of the automatic transmission 104 so the applied load from the engagement of the parking gear 124a and the parking pole 124b can be reduced even without outputting opposing torque. As a result, it is easier for the driver to shift the shift lever 4a out of the P range.

(B). When the driver issues a command for acceleration after the parking lock load has been reduced (i.e., yes in step S512), a process to stop control to maintain the restricting force against the driving wheels 112 and 114 (S514) is executed as a post-process. Accordingly, after the parking lock load is reduced the vehicle may be kept stable and driving by the driver may be started smoothly.

(C). The same effects as those described in (B), (C), and (D) in the first example embodiment are obtained.

In the first example embodiment (FIG. 1), the electric motor 48 is provided on the output shaft 6 of the automatic transmission 4. However, when a power source such as, for example, an electric motor for rotating the output shaft in order to run the vehicle is provided separately, the power source may also be used to output torque to the parking gear in a direction that reduces the applied load between the parking gear and the parking pole. Also, instead of providing a separate electric motor or the like, output from the engine or starter motor may be used to output torque to the parking gear in a direction that reduces that applied load.

In the first and second example embodiments described above, the applied load between the parking gear and the parking pole (i.e., the shift-from-P load) is calculated according to the inclination of the vehicle detected by the vehicle inclination sensor. Alternatively, however, the applied load between the parking gear and the parking pole (i.e., the shift-from-P load) may also be obtained by another method. For example, a deformation sensor may be attached to, for example, the base of the pawl of the parking pole, and the applied load (i.e., the shift-from-P load) may be calculated from the detected degree of deformation. Also, the applied load (i.e., the shift-from-P load) may be calculated by detecting the degree of torsion on the output shaft between the parking gear and the driving wheels with using a deformation sensor or an optical sensor or the like.

In the first and second example embodiments described above, the applied load between the parking gear and the parking pole is detected as the shift-from-P load. Alternatively, however, the parking lock load reducing routine may also be executed without detecting this applied load or the shift-from-P load. That is, when the conditions in both steps S106 and S108 in FIG. 5 are satisfied, the shift-from-P execution flag Fpa may be set to ON without performing steps S102 and S104. Also, if the vehicle is stopped and the shift lever 4a is in the P range, the routine for determining whether the executing condition for reducing the parking lock load is satisfied in FIG. 5 may be executed from step S110 without executing steps S102 to S108 in that routine, i.e., without determining the whether the executing conditions for reducing the parking lock load are satisfied (i.e., S104 to S108).

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the spirit and scope of the invention.

What is claimed is:

1. An apparatus that facilitates release of a parking lock by reducing an applied load on the parking lock, the apparatus comprising:
a control portion that executes a parking lock load reducing routine to apply torque to a parking gear in a direction that will reduce the applied load between the parking gear and a parking pole while movement of a driving wheel is restricted by a restricting force, and to reduce the restricting force on the driving wheel until the parking gear is rotated by the torque, when releasing the parking lock of an automatic transmission.

2. The apparatus according to claim 1, wherein the control portion executes a post-process that restricts movement of the driving wheel again after executing the parking lock load reducing routine.

3. The apparatus according to claim 1, further comprising:
an indicating device that indicates that a shift from a P range into another range is possible when the parking lock load reducing routine is complete.

4. The apparatus according to claim 3, wherein the control portion executes the parking lock load reducing routine again when it is determined that a shift from the P range into another range is not possible after the indicating device indicates that a shift from a P range into another range is possible.

5. The apparatus according to claim 3, wherein the indicating device also indicates that the parking lock load is being reduced.

6. An apparatus that facilitates release of a parking lock by reducing an applied load on a parking lock, the apparatus comprising:
a driving wheel braking force adjusting apparatus that adjusts a braking force applied to a driving wheel;
a parking gear torque outputting apparatus that outputs torque to rotate a parking gear;
a parking gear rotation detector that detects rotation of the parking gear;
a driving wheel restricting portion that executes a process to maintain movement of the driving wheel in a restricted state by controlling the adjustment of the braking force by the driving wheel braking force adjusting apparatus;
an applied load reducing portion that executes a process to reduce the applied load by controlling the parking gear torque outputting apparatus to output torque to the parking gear in a direction that reduces the applied load between the parking gear and a parking pole, after movement of the driving wheel is maintained in a restricted state by the driving wheel restricting portion; and
a driving wheel restricting force gradual reducing portion that executes a process to gradually reduce the restricting force on the driving wheel applied by the driving wheel restricting portion until the parking gear rotation detecting portion detects rotation of the parking gear of an amount equal to a reference angle while torque is being output by the applied load reducing portion.

7. The apparatus according to claim 6, further comprising:
a command input device that inputs a command to execute a parking lock load reducing routine,
wherein the process to reduce the applied load and the process to gradually reduce the restricting force on the driving wheel are executed when a command has been input with the command input device.

8. The apparatus according to claim 7, wherein the process to reduce the applied load and the process to gradually reduce the restricting force on the driving wheel are executed only if an operating state of a vehicle satisfies an executing condition for reducing the parking lock load.

9. The apparatus according to claim 6, further comprising:
a post-processing portion that executes a process to restrict the movement of the driving wheel again and to stop maintaining restricting force on the driving wheel when there is a command for acceleration, after the process to gradually reduce the restricting force on the driving wheel has been executed.

10. The apparatus according to claim 8, wherein the executing condition for reducing the parking lock load is a logical product of all of i) a condition that the applied load between the parking gear and the parking pole be greater than a reference load, ii) a condition that a parking brake be applied, and iii) a condition that a footbrake be applied.

11. The apparatus according to claim 6, further comprising:
an indicating device that indicates that a shift from a P range into another range is possible when the process to gradually reduce the restricting force on the driving wheel is complete.

12. The apparatus according to claim 11, further comprising:
a re-executing portion that executes the process to restrict the driving wheel, the process to reduce the applied load, and the process to gradually reduce the restricting force on the driving wheel again, when it is determined that a shift from the P range into another range is not possible after the indicating device indicates that a shift from a P range into another range is possible.

13. The apparatus according to claim 11, wherein the indicating device also indicates that the parking lock load is being reduced.

14. An apparatus that facilitates release of a parking lock by reducing an applied load on a parking lock, the apparatus comprising:
a control portion that executes a parking lock load reducing routine to reduce a binding force for transmitting torque between a driving wheel and a parking gear while movement of the driving wheel is restricted, when releasing the parking lock of an automatic transmission.

15. The apparatus according to claim 14, further comprising:
an indicating device that indicates that a shift from a P range into another range is possible when the parking lock load reducing routine is complete.

16. The apparatus according to claim 15, wherein the control portion executes the parking lock load reducing routine again when it is determined that a shift from the P range into another range is not possible after the indicating device indicates that a shift from a P range into another range is possible.

17. The apparatus according to claim 15, wherein the indicating device also indicates that the parking lock load is being reduced.

18. An apparatus that facilitates release of a parking lock by reducing an applied load on a parking lock, the apparatus comprising:
a driving wheel braking force adjusting apparatus that adjusts braking force applied to a driving wheel;
a driving force transmitting clutch that is provided between a parking gear and the driving wheel;
a driving wheel restricting portion that executes a process to maintain movement of the driving wheel in a restricted state by controlling the adjustment of the braking force by the driving wheel braking force adjusting apparatus; and
a clutch binding force reducing portion that executes a process to reduce a binding force of the driving force transmitting clutch after movement of the driving wheel is maintained in the restricted state by the driving wheel restricting portion.

19. The apparatus according to claim 18, further comprising:
a command input device that inputs a command to execute a parking lock load reducing routine,
wherein the clutch binding force reducing portion executes the process to reduce the binding force of the driving force transmitting clutch when a command has been input with the command input device.

20. The apparatus according to claim 19, wherein the process to reduce the binding force of the driving force transmitting clutch is executed only if an operating state of a vehicle satisfies an executing condition for reducing the parking lock load.

21. The apparatus according to claim 18, further comprising:
a post-processing portion that executes a process to stop maintaining the restricting force on the driving wheel when there is a command for acceleration after the process to reduce the binding force of the driving force transmitting clutch has been executed.

22. The apparatus according to claim 20, wherein the executing condition for reducing the parking lock load is a logical product of all of i) a condition that the applied load between the parking gear and a parking pole be greater than a reference load, ii) a condition that a parking brake be applied, and iii) a condition that a footbrake be applied.

23. The apparatus according to claim 18, further comprising:
an indicating device that indicates that a shift from a P range into another range is possible when the process to reduce the binding force of the driving force transmitting clutch is complete.

24. The apparatus according to claim 23, further comprising:
a re-executing portion that executes the process to restrict movement of the driving wheel and the process to reduce the binding force of the driving force transmitting clutch again when it is determined that a shift from the P range into another range is not possible after the indicating device indicates that a shift from a P range into another range is possible.

25. The apparatus according to claim 23, wherein the indicating device also indicates that the parking lock load is being reduced.
